(19) United States
(12) Patent Application Publication
(10) Pub. No.: US 2023/0069699 A1
(43) Pub. Date: Mar. 2, 2023

(54) Gaming Mouse Wireless Dongle and Charging Adapter with Magnetic Instant Connect

(71) Applicant: Dell Products L.P., Round Rock, TX (US)

(72) Inventors: Peng Lip Goh, Singapore (SG); Victor C. Cheung, Singapore (SG)

(73) Assignee: Dell Products L.P., Round Rock, TX (US)

(21) Appl. No.: 17/462,085

(22) Filed: Aug. 31, 2021

(51) Int. Cl. G06F 1/16; G06F 1/18

(52) U.S. Cl. CPC G06F 1/169; G06F 1/182

(57) ABSTRACT

An adapter provides wireless communication and charging to a wireless mouse. The adapter includes a wireless dongle that provides wireless communication to the wireless mouse. A charging plug connected to a cable provides charging. The adapter and wireless mouse include interfaces that magnetically the adapter to the wireless mouse when in close proximity. A shroud on the adapter provides physical security when the adapter and wireless mouse are connected.

### BACKGROUND OF THE INVENTION

### Field of the Invention

The present invention relates to information handling systems. More specifically, embodiments of the invention provide a gaming mouse wireless dongle and charging with magnetic instant connect used for information handling systems.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A popular user interface and information handling system peripheral is the computer mouse. The computer mouse allows a user to interface with software applications running on the information handling system by manipulating the mouse through the hand of the user. The mouse can transmit physical gestures to actions performed by the software application. These types of actions are prevalent in gaming applications running on information handling system.

When using a wireless mouse, a gaming user can experience problems that include lack of instant charging and an unstable wireless connection. For example, gaming users that play for an extended period can experience a need to charge their wireless mouse. The gaming user may have to stop the game to dock the wireless mouse on a charging docking station or momentarily stop the game to manually plug a charging cable to a charging port of the wireless mouse. Such instances interrupt the gaming experience. In certain instances, an information handling system can be a bulky desktop computer placed on the ground and a considerable distance from the wireless mouse, or the information handling system is placed at a distance that includes barriers that prevent a continuous connection. A discontinuous connection can lead to a poor gaming experience.

### SUMMARY OF THE INVENTION

An adapter to provide wireless communication and charging to a wireless mouse, comprising: a wireless dongle that provides the wireless communication to the wireless mouse; a charging plug connected to a cable to provide the charging; an interface that magnetically connects to an interface of the wireless mouse when charging is performed; and a shroud that secures the interface to the interface of the magnetic mouse.

A wireless mouse comprising: an interface that magnetically connects to an adapter that provide wireless communication and charging to the wireless mouse, wherein the interface is surrounded by a shroud of the adapter when charging is performed; communication to a wireless dongle of the adapter; and charging through the interface when connected to the adapter

A method of connecting and disconnecting a wireless mouse to wireless adapter comprising: maintaining wireless communication between the wireless mouse and wireless adapter; magnetically connecting the wireless mouse and wireless adapter; physically securing the wireless mouse and wireless adapter; charging the wireless mouse through the wireless adapter; and disconnecting the wireless mouse from the wireless adapter when charging is complete.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2A illustrates an unconnected wireless mouse and adapter as implemented in the present invention;

FIG. 2B illustrates a connected wireless mouse and adapter as implemented in the present invention;

FIG. 2C illustrates an unconnected wireless mouse and adapter and support structures as implemented in the present invention;

FIG. 2D illustrates connectors of a wireless mouse and an adapter as implemented in the present invention;

FIG. 3 illustrates a cross section of a connected wireless mouse and adapter as implemented in the present invention;

FIG. 4A illustrates an adapter with wireless dongle and charging as implemented in the present invention;

FIG. 4B illustrates an adapter with USB connections to receive a wireless dongle and charging as implemented in the present invention;

FIG. 5 illustrates a wireless mouse with USB receptacle and a magnetic receptacle; and

FIG. 6 is a generalized flowchart for connecting and disconnecting a wireless mouse to an adapter with wireless dongle and charging.

### DETAILED DESCRIPTION

Various implementations provide for a robust instant and stable connection between a wireless mouse and an adapter that provides for a wireless dongle and charging. The wireless dongle providing a continuous connection between the wireless mouse and an information handling system. The charging providing instant power and charging to the wireless mouse. The adapter allows a user to continuously use the wireless mouse without interruption of the use of applications, such as gaming applications.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

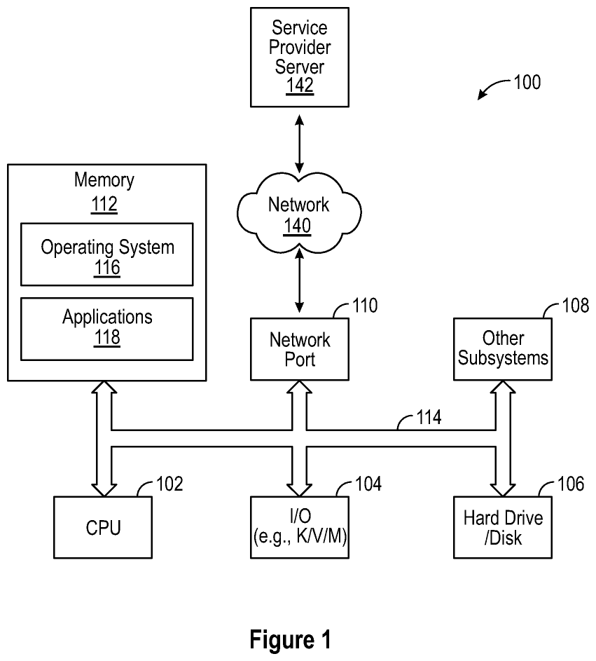

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108. In various embodiments, I/O devices 104 include the wireless mouse described herein, which is connected to the adapter described herein. The wireless mouse and adapter connected via a wireless connection, such as standards defined by IEEE 802.11.

In various embodiments, the information handling system 100 also includes network port 110 operable to connect to a network 140, where network 140 can include one or more wired and wireless networks, including the Internet. Network 140 is likewise accessible by a service provider server 142. The information handling system 100 likewise includes system memory 112, which is interconnected to the foregoing via one or more buses 114. System memory 112 can be implemented as hardware, firmware, software, or a combination of such.

System memory 112 further include operating system (OS) 116. In various embodiments, OS 116 manages all of the software and hardware on the information handling system 100. Implementations provide for the system memory 112 to include applications 118, such as gaming applications.

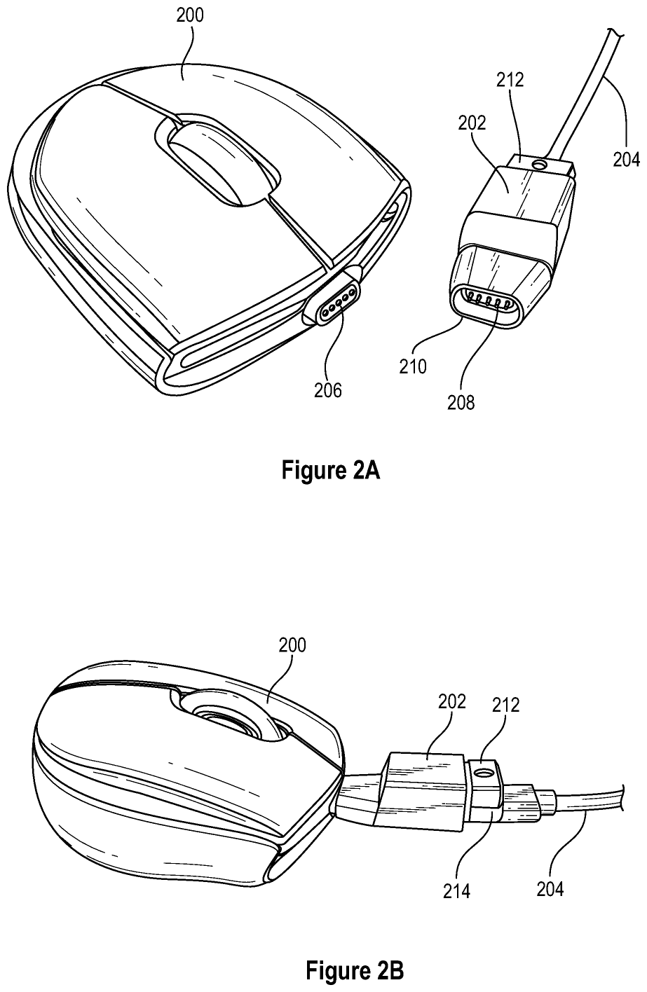

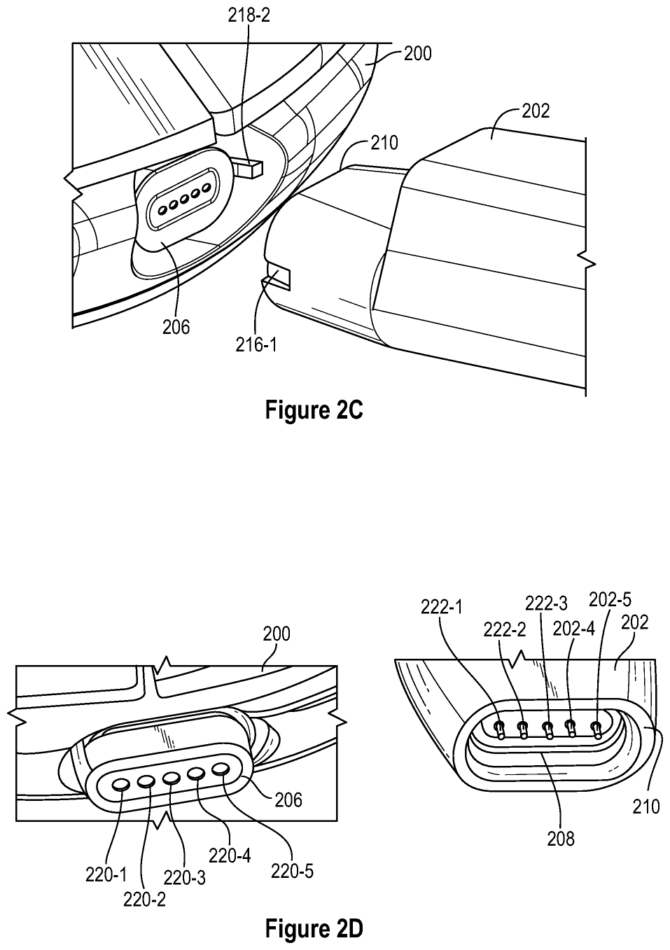

FIG. 2A shows an unconnected wireless mouse and adapter as implemented in the present invention. A wireless mouse 200 connects with an adapter 202. The adapter 202 is connected by a wired interface/cable 204 to information handling system 100, such as a desktop or laptop computer. wireless connectivity. The adapter 202 is of sufficient weight, for example 8 ounces, to prevent movement when a user connects/disconnects the wireless mouse 200. Implementations also provide for the adapter to be securely attached to a use surface to prevent movement when connecting/disconnecting the wireless mouse 200.

Implementations provide for the wireless mouse 200 to include an interface 206 to connect to an interface 208 of the adapter 202. Implementations include interface 206 and interface 208 to be magnetically connected, where interface 206 and interface 208 have opposite magnetic polarity. Such a magnetic connection can provide greater connectivity in physically securing the wireless mouse 200 to the adapter 202.

Various implementations provide for the adapter 202 to include a shroud 210 that is secured to and completely surrounds a protruding interface 206. The shroud 210 provides additional security when the mouse 200 and adapter are physically connected.

Implementations provide for the wireless mouse 200 and the adapter 202 to have continuous wireless communication, allowing a user to have interrupted access and use to the information handling system 100. The adapter 202 can include a wireless dongle 212 that maintains the wireless communication to the mouse 200. Examples of wireless communication include various standards, such as IEEE 802.11 WiFi communications. An example is USB-C WiFi implemented wireless communication. The wireless communication that is chosen should be robust to maintain low latency and continuous connectivity. Furthermore, because the wireless mouse 200 and adapter 202 are in close proximity to one another, low latency can be maintained.

FIG. 2B shows physically connected wireless mouse 200 and adapter 202. When charging is required, the wireless mouse 200 is physically connected to the adapter 202. As discussed, wireless communication is continuously maintained between wireless mouse 200 and adapter 202. In particular, the wireless dongle 212 provides a wireless connection to the wireless mouse 200.

Whenever the wireless mouse 200 needs charging, physical connection is made with the wireless mouse 200 and the adapter 202. Implementations provide for a charging plug 214 to be attached to the adapter 202. Implementations provide for the wired interface/cable 204 to provide power to the charging plug 214.

As discussed, the adapter 202 is of sufficient weight or secured to assure that when physical connection/disconnection is performed with the wireless mouse, that the adapter 202 is not easily displaced. Implementations can further provide for the wireless mouse 200 and adapter 202 to be angled. Such an angle can provide for a “lead in” that allows a user to easily connect and disconnect the wireless mouse 200 and adapter 202.

FIG. 2C shows an unconnected wireless mouse 200 and adapter 202 and support structures as implemented in the present invention. As discussed, shroud 210 is secured to and completely surrounds protruding interface 206 when the wireless mouse 200 and adapter 202 are physically connected to one another. The shroud 210 provides additional security to a physically connected mouse 200 and adapter 202.

In various implementations, further security to assure that mouse 200 and adapter 202 are not easily disconnected, include slots 216 on either side of the adapter 202. Shown is one slot 216-1. Tabs 218 on the wireless mouse 200 fit into corresponding slots 216. Shown is one slot 218-2. When connected, the slots 216 and tabs 218 provide an additional secure physical connection between wireless mouse 200 and adapter 202.

FIG. 2D shows connectors of wireless mouse 200 and adapter 202. The connectors are shown as interface 206 on wireless mouse 200, and interface 208 on adapter 202. As discussed, the interface 206 can protrude and is surrounded by shroud 210. Interface 206 and interface 208 can be magnetically connected, where interface 206 and interface 208 have opposite magnetic polarity. Various implementations provide for the interface 206 to have multiple pogo pin holes 220, and for the interface 208 to have pogo pins 222. Pogo pin holes 220 receive pogo pins 222. When wireless mouse 200 and adapter 202 are connected through respective interfaces 206 and 208, the connection with pogo pin holes 220 and pogo pins 222 provide an additional secure physical connection.

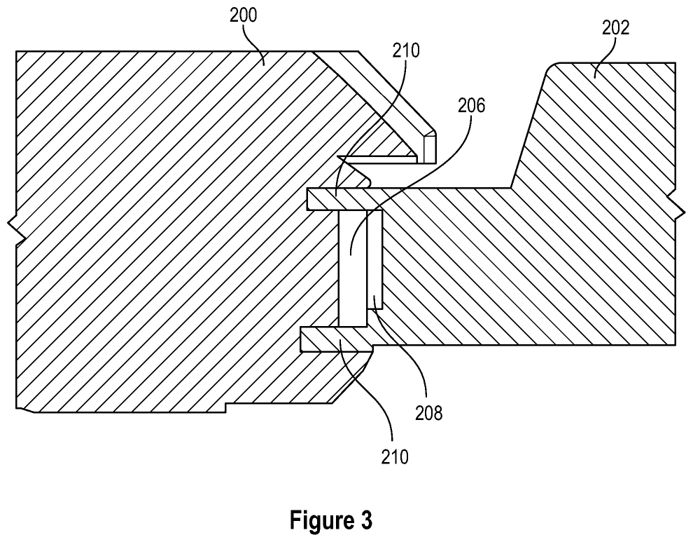

FIG. 3 shows a cross section of connected wireless mouse 200 and adapter 202. As discussed, a physical connection is performed between the wireless mouse 200 and adapter 202, and particularly when charging of the wireless mouse is needed. Interface 206 of the wireless mouse 200 connects with interface 208 of the adapter 202. In various implementations the connections between interfaces 206 and 208 is magnetic and can be supported with pogo holes 220 and pogo pins 222 as described. As also described additional structural supports, such as tabs 218 and slots 216.

Implementations provide for the shroud 210 to surround the interface 206 of the wireless mouse 200 to provide a secure physical connection. In various implementations, the shroud is a part of external housing of the adapter 202.

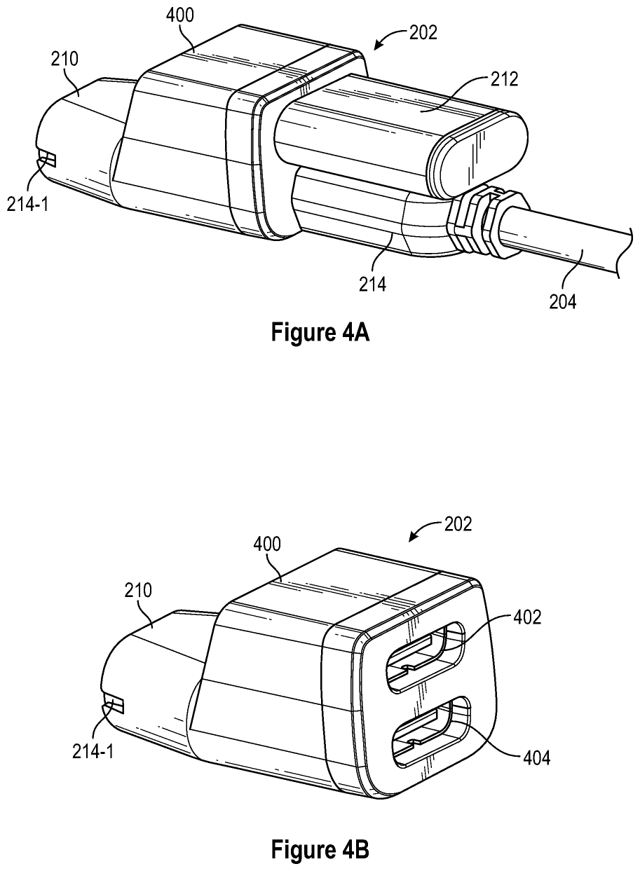

FIG. 4A shows adapter 202 with wireless dongle 212 and charging. Implementations provide for the wired interface/cable 204 to be connected to information handling system 100, such as a desktop or laptop computer, and to connect to or include a charging plug 214. The charging plug 214 can be attached to the adapter 202. Wireless dongle 202 can also be attached to and unattached from the adapter 202. Implementations can provide for the adapter 202 to include an indented feature 400 that allows a user to push away the wireless mouse 200 from the adapter 202 when physical disconnecting the wireless mouse and adapter 202. For example, when charging of the wireless mouse 200 is complete, and a user desires to separate the wireless mouse 200 from the adapter 202, with a finger, the user can push away from the adapter 202 to disengage the wireless mouse 200.

FIG. 4B shows adapter 202 with USB connections to receive wireless dongle 212 and charging. In certain implementations, the wireless dongle 212 and charging plug 214 are separate from the adapter 202. Implementations provide for the adapter 202 to be connected to wireless dongle 212 and charging plug 214 through USB connections, such as USB-C. Implementations provide for the adapter 202 to include a USB connection 402 for wireless dongle 212, and a USB connection 404 for charging plug 214. The wireless dongle 212 plugs into USB connection 402 and charging plug 214 plugs into USB connection 404.

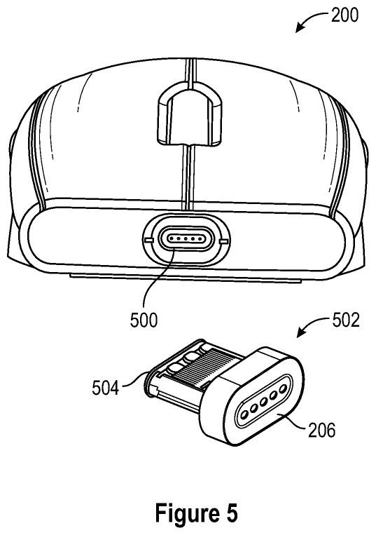

FIG. 5 shows wireless mouse 200 with a USB receptacle, and a separate magnetic receptacle. Various implementations provide for the wireless mouse 200 and the interface 206 to be separate components. In particular, to allow the wireless mouse 200 to operate in a wired configuration, an interface 500 is provided to connect with a wired connection which can be connected to information handling system 100. For example, the interface 500 can be a USB-C interface. Implementations provide for a receptacle 502 that can include interface 206. The receptacle 502 includes an interface 504 that connects with interface 500 and secures the receptacle 502 to wireless mouse 200. Interface 500 can be a female USB-C connection and interface 504 can be a male USB-C connection.

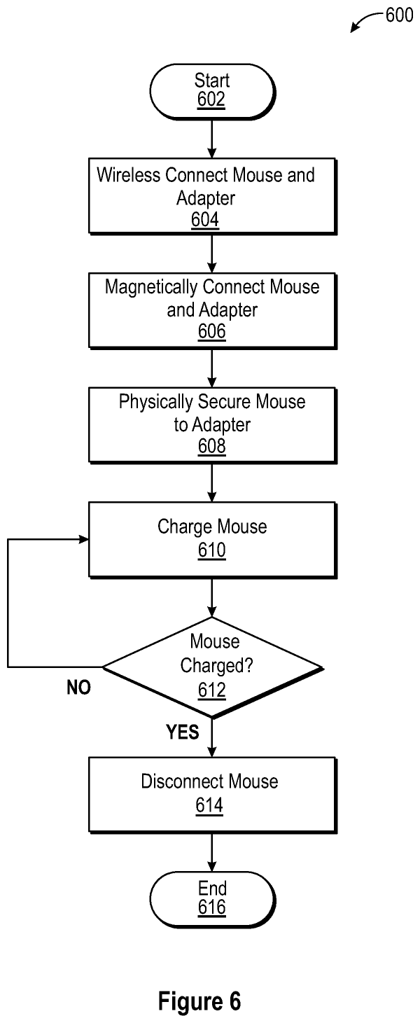

FIG. 6 is a generalized flowchart for connecting and disconnecting wireless mouse 200 to adapter 202 with wireless dongle and charging. The order in which the method is described is not intended to be construed as a limitation, and any number of the described method blocks may be combined in any order to implement the method, or alternate method.

At step 602, the process 600 starts. At step 604, the wireless mouse 200 is wireless connected to the adapter 202. The wireless dongle 212 that maintains wireless communication to the mouse 200 maintaining a robust wireless connection with low latency between wireless mouse 200 and adapter 202.

At step 606, the wireless mouse 200 and adapter 202 are magnetically connected. As the wireless mouse 200 moves closer to the adapter 202, respective interfaces 206 and 208, which have opposite magnetic polarity are attracted to one another. Implementations provide for interfaces 206 and 208 to include pogo pin holes 220 and pogo pins 220 to connect with one another. Magnetic attraction along with pogo pin holes 220 and pogo pins 220 allow for ease of connection for wireless mouse 200 and adapter 202. An angled “lead in” further can provide ease of connection between the wireless mouse 200 and adapter 202.

At step 608, the wireless mouse 200 and adapter 202 are physically secured to one another. Shroud 210 on interface 208 of adapter 202 surrounds protruding interface 206. In addition, slots 216 and tabs 218 provide added physical connection security.

At step 610, the wireless mouse 200 is charged. Implementations provide for the wired interface/cable 204 to provide power to the adapter 200 to charge the wireless mouse 200. Implementations provide or wired interface/cable 204 to include charging plug 214.

At step 612, a determination is performed whether the wireless mouse 202 is charged. If not charged, following the NO branch of step 612, step 610 is performed. If the wireless mouse 202 is charged, then following the YES branch of step 614, the wireless mouse 200 is disconnected from the adapter 202. The adapter 202 should have sufficient weight or secured to the use surface, such as a table top, to prevent the adapter 202 from moving when connecting and disconnecting the wireless mouse 200. In various implementations, the adapter 202 has a form factor that provides indented feature 400 that allows a user to push away the wireless mouse 200 from the adapter 202 when physical disconnecting the wireless mouse and adapter 202. At step 616, the process 600 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

1. An adapter to provide wireless communication and charging to a wireless mouse, comprising:
a wireless dongle that provides the wireless communication to the wireless mouse;
a charging plug connected to a cable to provide the charging;
a protruding interface that magnetically connects to an interface of the wireless mouse when charging is performed, wherein the interface is configured for wired and wireless connection of the wireless mouse to an information handling system; and
a shroud that secures the completely surrounds the protruding interface to the interface of the wireless mouse, wherein the shroud provides secure connection when the adapter and mouse are connected.

2. The adapter of claim 1, wherein the wireless dongle supports IEEE 802.11 WiFi standards.

3. The adapter of claim 1, wherein the wireless dongle and charging plug are removable from the adapter.

4. The adapter of claim 3, wherein the adapter provides USB connections for the removable wireless dongle and charging plug.

5. The adapter of claim 1, wherein the interfaces include pogo pins and pogo pin holes.

6. The adapter of claim 1 further comprising slots to accept tabs of the wireless mouse when connection is performed.

7. The adapter of claim 1, wherein the adapter is of a weight of eight ounces or more to secure the adapter on a use surface when connecting or disconnecting the wireless mouse.

8. The adapter of claim 1 further comprising an ident feature to allow a user to separate the wireless mouse from the adapter.

9. The adapter of claim 1, wherein the adapter is angled to the wireless mouse to provide a lead in for connection.

10. A wireless mouse comprising:
an interface that magnetically connects to a protruding interface of an adapter that provides wireless communication and charging to the wireless mouse, and wired and wireless connection to an information handling system, wherein the protruding interface is completely surrounded and secured by a shroud of the adapter when charging is performed, wherein the shroud provides a secure connection the wireless mouse and adapter when connected;
communication to a wireless dongle of the adapter; and
charging through the interface when connected to the adapter.

11. The wireless mouse of claim 10, wherein the interface includes pogo holes to connect to pogo pins of an interface of the adapter.

12. The wireless mouse of claim 10 further comprising tabs that fit into grooves of the adapter when connection is performed.

13. The wireless mouse of claim 10, wherein the wireless mouse is angled to the adapter to provide a lead in for connection.

14. The wireless mouse of claim 10 further comprising a USB interface that accepts a wired connection.

15. The wireless mouse of claim 14, wherein the USB interface accepts a receptacle that includes the interface that magnetically connects to the adapter.

16. A method of connecting and disconnecting a wireless mouse to wireless adapter comprising:
maintaining wireless communication between the wireless mouse and wireless adapter;
magnetically connecting the wireless mouse and wireless adapter;
physically securing by a shroud the wireless mouse and wireless adapter, wherein the shroud completely surrounds a protruding interface of the wireless adapter;
providing wired and wireless connection of the wireless mouse to an information handling system;
charging the wireless mouse by an interface that connects to the protruding interface of the wireless adapter; and
disconnecting the wireless mouse from the wireless adapter when charging is complete.

17. The method of claim 16, wherein a wireless dongle provides communication from the adapter to the wireless mouse.

18. The method of claim 16, wherein the magnetically connecting is further supported by pogo holes and pogo pins.

19. The method of claim 16, wherein physically securing includes a shroud of the adapter that surrounds an interface of the wireless mouse.

20. The method of claim 19, wherein the physically securing further includes grooves and tabs that secure the wireless mouse to the adapter.

21. The method of claim 16, wherein the disconnecting is performed with an ident feature of the adapter.
